(19) United States
(12) Patent Application Publication
(10) Pub. No.: US 2008/0246726 A1
(43) Pub. Date: Oct. 9, 2008

(54) Portable electronic device having a pliable or flexible portion

(75) Inventor: Shawn R. Gettemy, San Jose, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/011,471

(22) Filed: Jan. 25, 2008

Related U.S. Application Data
(63) Continuation of application No. 10/241,157, filed on Sep. 11, 2002, now abandoned.

(51) Int. Cl. G06F 3/033

(52) U.S. Cl. 345/158

(57) ABSTRACT

A portable electronic device or handheld computer is disclosed. The device has a housing and computing electronics supported by the housing. A pliable sensor that is supported by the housing is also disclosed. The pliable sensor provides input from the hand of a user by applying pressure to the pliable sensor.

### CROSS-REFERENCE TO RELATED APPLICATIONS

The present application is a continuation of U.S. application Ser. No. 10/241,157 filed Sep. 11, 2002, which is incorporated herein by reference in its entirety.

### BACKGROUND

The invention relates generally to the field of portable electronic devices and handheld computers. More particularly, the invention relates to portable electronic devices and handheld computers including flexible and/or pliable sensors. Further, the invention relates to portable electronic devices and handheld computers including flexible input sensors used to provide navigation on a display of the portable electronic device or handheld computer.

Conventionally, portable electronic devices include visible displays, such as liquid crystal displays (LCDs) and other similar displays. Such displays may be incorporated into any of a variety of portable electronic devices, such as mobile telephones, handheld computers, personal digital assistance (PDAs), laptop computers, and the like. Because of the small form factor required for such portable electronic devices, many conventional portable electronic devices also include some integrated types of input devices, for example, touch screens, buttons, thumb wheels (oy dials), integrated keyboards, and the like. Such input devices are provided to enable users to provide input to the portable electronic device and further to navigate a cursor or like device on the display.

Because there is a desire for very thin, lightweight, and power conserving displays and/or displays that are flexible and/or expandable, and further because there is a desire to have input devices on the portable electronic device that are simple to use and ergonomic, conventional input devices may not be satisfactory.

Accordingly, there is a need for an input device that is flexible and/or pliable and may be integrated into the housing and/or the display of a portable electronic device. Further, there is a need for a flexible and pliable input device that may be used to navigate on a display by providing at least one of pressure, bending, twisting, folding, and/or pulling motions to the flexible and/or input device sensor. Further still, there is a need for a method of providing navigation on a display screen by using a flexible and/or pliable input device sensor. Yet further still, there is a need for a flexible and/or pliable input sensor that is integrated into a flexible and/or pliable electronic device for providing input and navigation capabilities thereto.

It would be desirable to provide a system and/or method that provides one or more of these or other advantageous features. Other features and advantages will be made apparent from the present specification. The teachings disclosed extend to those embodiments which fall within the scope of the appendent claims, regardless of whether they accomplish one or more of the aforementioned needs.

### SUMMARY

An example of the invention relates to a portable electronic device. The portable electronic device includes a housing. The portable electronic device also includes computing electronics supported by the housing. Further, the portable electronic device includes a pliable sensor supported on the housing. The pliable sensor provides input from a hand of a user by applying pressure to the pliable sensor.

Another example of the invention relates to a handheld computer. The handheld computer includes a housing. The handheld computer also includes computing electronics supported by the housing. Further, the handheld computer includes a display supported by the housing. Further still, the handheld computer includes a deformable sensor supported on the housing. The deformable sensor provides input from a hand of a user by deformation of the deformable sensor.

Yet another example of the invention relates to a method of providing input to a portable electronic device. The method includes grasping with a hand, the housing of the portable electronic device. The housing supports a pliable sensor. At least a portion of the hand covers at least a portion of the pliable sensor. The method also includes providing pressure with a portion of the hand to the pliable sensor.

Yet still another example of the invention relates to a portable electronic device. The portable electronic device includes a means for grasping with the hand, the housing of the portable electronic device. The housing supports a pliable sensor. At least a portion of the hand covers at least a portion of the pliable sensor. The portable electronic device also includes a means for providing pressure, with a portion of the hand, to the pliable sensor.

Alternative examples of the invention relate to other features and combination of features as may be generally recited in the claims.

### BRIEF DESCRIPTION OF THE DRAWINGS

The invention will become more fully understood from the following detailed description taken in conjunction with the accompanying drawings, wherein like reference numerals refer to like elements in which:

FIG. 1 is an exemplary block diagram of a handheld computer;

FIG. 2 is an exemplary depiction of a handheld computer including a flexible or pliable sensor;

FIG. 3 is an alternative exemplary depiction of a handheld computer including a flexible or pliable sensor and depicting exemplary directions and/or motions in which the handheld computer may be deformed; and

FIG. 4 is an exemplary depiction of a handheld computer including a flexible or pliable sensor and being held by the hand of a user.

### DETAILED DESCRIPTION OF EXEMPLARY EMBODIMENTS

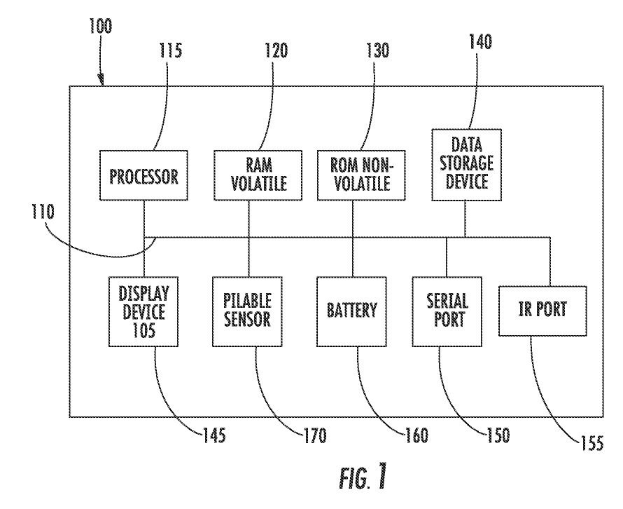

Referring to FIG. 1, a handheld or portable computer system 100 is depicted according to an exemplary embodiment. Handheld computer system 100 is representative of many of the portable electronic devices on which embodiments of the invention may be implemented, including, but not limited to PDAs, personal information managers (PIMs), palm tops, handheld computers, cellular telephones, wireless communicators, and other information and data processing devices.

Handheld computer 100 includes a communications bus 110 used to communicate information between devices coupled to communications bus 110. Handheld computer 100 also includes a processor 115 that is used to process information and instructions. Processor 115 is coupled to communications bus 110. A volatile memory 120 such as a random access memory (RAM) is coupled to bus 110 and may be used to store information and instructions for processor 115. A non-volatile memory 130 which may be a read-only memory (ROM) is coupled to bus 110. Non-volatile memory 130 may be used to store static information and instructions that are used by processor 115. Handheld computer system 100 may further include, a data storage device 140 such as, but not limited to a removable memory card (for example, a secured digital (SD) memory card). A storage device 140 is coupled to bus 110 to store information and instructions to be used by processor 115. Handheld computer 100 may also include a display 145, such as but not limited to an LCD display, a flexible display such as an e-paper display (such as E-ink, Smart Paper™, Gyricon Media, APD™ by Citala, etc.), other bistable displays, or any other type of applicable visual display. Display 145 is used for displaying information to the computer user and further for providing a user interface to aid the user in providing input to handheld computer 100. Further, handheld computer 100 may include a plurality of input/output ports and connections including, but not limited to a serial port 150 and an infrared (IR) port 155. Communication ports 150 and 155 are coupled to communications bus 110. A power source, such as a battery 160 is coupled to bus 110 and provides power for devices connected thereto.

In an exemplary embodiment, a pliable sensor 170 is coupled to communications bus 110. Pliable sensor 170 may be supported by the housing of handheld computer 100. Flexible or pliable sensor 170 may be used to provide input to handheld computer 100 by a user. Flexible or pliable sensor 170 may be, but is not limited to a layer of flexible electric muscle material formed on the outer surface of handheld computer 100.

Electric muscle material is a dielectric elastomeric polymer material, sometimes referred to as an electroactive polymer. Electric muscle material has been shown to be useful as a transducer. When the dielectric elastomeric material is stretched, an electrical charge in the material is produced. This electrical charge may be sensed and measured. Conversely, when an electric charge is provided to the dielectric elastomer, deformation of the material may occur. Dielectric elastomeric materials have been demonstrated by Ron Pelrine, et al. of SRI International, Menlo Park, Calif.

Pliable sensor 230 may also be formed of an electrotextile material. Electrotextiles are a soft, flexible, and lightweight sensing and switching fabric. When the fabric is touched, for example, the contact point may be located. The fabric translates electronic impulses, sensed by the fabric field into digital data. Electrotextiles are available from Eleksen Company Ltd., of Buckinghamshire, GB. Further, pliable sensor 230 may be any of a variety of sensors which may sense flexure such as strain gauges and the like. Such sensors may be incorporated into housing 210 and/or display 220.

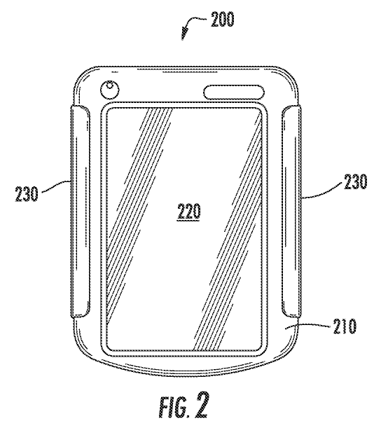

Referring now to FIG. 2, an exemplary embodiment of a handheld computer 200 is depicted. Handheld computer 200 includes a housing 210 supporting computing electronics, as described with respect to FIG. 1, or other similar electronics. Handheld computer 200 also includes a display 220 configured to display information to a user. A display 220 may be used to display any type of visual information, including, but not limited to user interfaces, pictures, text, video, and the like. In an exemplary embodiment, handheld computer 200 may include a pliable sensor 230. Pliable sensor 230 may be any of a variety of pliable and/or flexible sensors including, but not limited to electrotextiles, and electroactive polymers for example electronic muscle material. Pliable sensor material 230 may be located on the exterior of the housing along edges of the housing or alternatively may be wrapped around the back of handheld computer 200. In yet another configuration, pliable sensor 230 may be located below the surface of housing 210 if housing 210 is also flexible and/or pliable.

In an exemplary embodiment, housing 210, display 220 as well as pliable sensor 230 are all flexible materials and the entirety or portions of handheld computer 200 may be flexed via input forces provided by a user. Pliable sensor 230 then senses such flexure and converts such flexure into an electrical signal which is interpreted by processor 115 as a particular type of input to handheld computer 200. Specific flexures may be correlated with particular actions on handheld computer 200. For example, flexure in one direction may cause scrolling of information on display 220, moving through various fields, selecting menu options, selecting various applications, and providing other various functions. Further, pressure may be applied, by the hand of a user, to particular areas of sensor 230. Electrical signals generated by such pressure may be correlated with specific functions of handheld computer 200 including navigation of information on display 220.

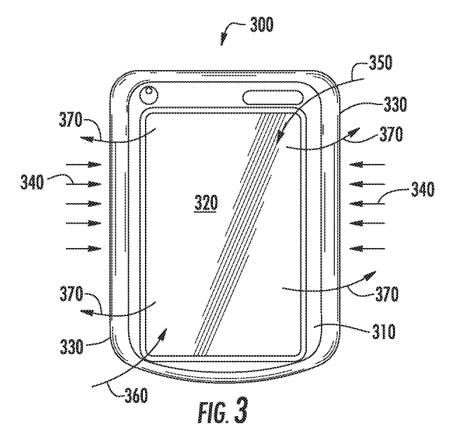

Referring now to FIG. 3, an alternative handheld computer configuration 300 is depicted. Handheld computer 300 includes a housing 310, a display 320 and a pliable sensor 230. Pliable sensor 230 is formed around the perimeter of handheld computer 300. In an exemplary embodiment, pliable sensor 330 may be an electronic muscle material or other electroactive polymeric material or pliable sensor 330 may be an electrotextile material. Utilizing the pliable sensor structure depicted in FIG. 3, a user may provide a variety of force inputs including but not limited to pressure on sides of the device or at certain points on the perimeter of the device indicated by arrows 340. A user may also twist the device by deflecting corners of the device, for example, a user may deflect inwardly the upper right-hand corner of the device in order to effectuate a certain action or function on display 320 as indicated by arrow 350. Similarly, other corners of the device may be flexed inwardly such as the lower left-hand corner indicated by arrow 360. In another exemplary embodiment, a user may deflect both sides of the device simultaneously as indicated by arrows 370. Further, other inputs and flexures may be provided by deforming pliable sensor 330 of handheld computer 300.

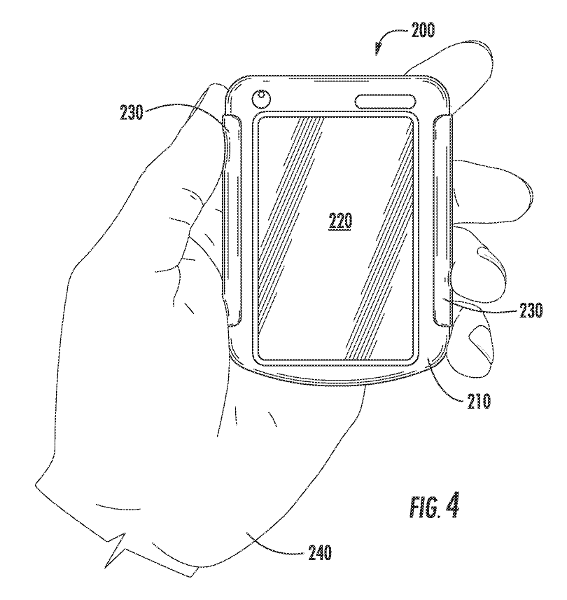

Referring now to FIG. 4, a hand 240 of a user of handheld computer 200 is depicted. Hand 240 grasps handheld computer 200 with fingers or other portions of hand 240 covering portions of pliable sensor 230. In a particular exemplary embodiment, with pliable sensor 230 being an electroactive polymeric material, handheld computer 200 may be configured to sense the location of hand 240 grasping device 200. In such a situation, handheld computer 200 may be configured to automatically provide appropriate charges to electroactive polymeric sensor 230 to provide protuberances of deformed electroactive polymer at certain areas on the electroactive polymer, for example below the fingertips of hand 240 in order to provide buttons or bumps. In an exemplary embodiment, sensor 230 and associated software may be configured to learn and/or correlate certain deformations of pliable sensor 230 with specific actions on the device. In an alternative embodiment, a user may be able to manually configure handheld computer 200 to correlate inputs via sensor 230. For example, specific inputs may be configured to start certain applications. Further, sensor 230 may be configured for the input of data, by configuring the sensor to recognize different motions as different letters or numbers, e.g., as a user places portions of hand 240 upon sensor 230, handheld computer 200 may be configured to detect the location of hand 240. Thereafter, handheld computer 200 may sense the movement and force applied by hand 240 in different directions. The information gathered from these inputs by hand 240 may be used to control navigation through information on handheld computer 200.

In an exemplary embodiment, a particular sequence of movements and forces can be used to configure an unlock security feature. For example, a user may train the device to recognize a sequence of motions before the user is able to access the device or specific information on the device.

A device utilizing a flexible and/or pliable sensor, such as sensors 170, 230, and 330 may provide a better user experience over conventional devices. The device may be easier to use, as well as more intuitive to a user. Further, such sensors may provide the device with a comfortable, soft, and pliable feel.

While the detailed drawings, specific examples and particular formulations and materials given described preferred exemplary embodiments, they serve the purpose of illustration only. The inventions disclosed are not limited to the specific forms shown. For example, the methods may be performed in any of a variety of sequence of steps. The hardware and software configurations shown and described may defer depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

1. (canceled)

2. A mobile computing device, comprising:
a housing;
a touch screen display;
a sensor; and
a processor, coupled to the touch screen display and the sensor;
wherein the sensor is configured to receive an input via the touch screen display and provide tactile feedback.

3. The mobile computing device of claim 2, wherein the mobile computing device is a handheld device.

4. The mobile computing device of claim 2, further comprising cellular telephone electronics.

5. The mobile computing device of claim 2, wherein the sensor is incorporated into the touch screen display.

6. The mobile computing device of claim 2, wherein the sensor sends signals to the processor based on the input.

7. The mobile computing device of claim 2, wherein the tactile feed back is a protrusion formed in the sensor.

8. The mobile computing device of claim 2, wherein the protrusion is provided at a location based in the location of the input on the touch screen display.

9. A cellular telephone comprising:
a housing;
a processor including cellular telephone electronics and disposed within the housing; and
a sensor configured to provide signals to the processor based on a force applied to the sensor by a user and to provide tactile feedback to the user in response to the force.

10. The cellular telephone of claim 9, further comprising a touch screen.

11. The cellular telephone of claim 10, wherein the sensor is coupled to the touch screen.

12. The cellular telephone of claim 11, wherein the tactile feedback is a protrusion formed in the sensor.

13. The cellular telephone of claim 9, further comprising a personal information manager application.

14. The cellular telephone of claim 9, wherein the sensor is incorporated into the housing.

15. The cellular telephone of claim 9, wherein the tactile feedback is a protrusion formed in a location determined based in the location of the force.

16. A mobile computing device, comprising:
a housing;
computing electronics;
a display coupled to the computing electronics and the housing; and
a force sensor coupled to the computing electronics and at least a portion of the surface of the housing to define an input device for the portable computer;
wherein the force sensor is configured to deform in response to a tactile input, and provide inputs to the computing electronics based on the location of the tactile input on the force sensor; and
wherein the computing electronics are configured to provide an alphanumeric character on the display in response to the tactile input.

17. The mobile computing device of claim 16, wherein the force sensor is configured to provide a button in response to the tactile input.

18. The mobile computing device of claim 16, wherein the display is configured to provide a plurality of visual user interfaces, and the processor is configured to permit a user to navigate through the plurality of visual user interfaces by the user providing the tactile input.

19. The mobile computing device of claim 16, wherein the computing electronics comprise cellular telephone electronics.

20. The mobile computing device of claim 16, wherein the mobile computing device is a handheld computer.

21. The mobile computing device of claim 20, wherein the display is a touch screen display.
